(19) United States
(12) Patent Application Publication
(10) Pub. No.: US 2010/0209338 A1
(43) Pub. Date: Aug. 19, 2010

(54) HYDROGEN-GENERATING MATERIAL COMPOSITION, HYDROGEN-GENERATING MATERIAL FORMED BODY, AND METHOD FOR PRODUCING HYDROGEN

(76) Inventors: Takeshi Miki, Osaka (JP); Toshihiro Nakai, Osaka (JP); Shoji Saibara, Osaka (JP)

Correspondence Address: BIRCH STEWART KOLASCH & BIRCH, PO BOX 747, FALLS CHURCH, VA, 22040-0747, US

(21) Appl. No.: 12/676,862

(22) PCT Filed: Sep. 3, 2008
(86) PCT No.: PCT/JP2008/065866

§ 371 Date: Mar. 5, 2010

(30) Foreign Application Priority Data
Sep. 5, 2007 (JP) 2007-230560

(51) Int. Cl. C01B 3/08; C09K 3/00

(52) U.S. Cl. 423/657; 252/182.12; 252/182.33; 252/182.35; 252/182.32

(57) ABSTRACT

A hydrogen-generating material composition of the present invention contains at least one metallic material selected from the group consisting of aluminum, silicon, zinc, magnesium, and alloys mainly composed of at least one of those metal elements, and a water-soluble salt of hydroxy acid. In the hydrogen-generating material composition, the ratio of the water-soluble salt of hydroxy acid to the total of the metallic material and the water-soluble salt of hydroxy acid is 1 mass % or more. A method for producing hydrogen according to the present invention is provided, wherein hydrogen is generated by supplying water to the hydrogen-generating material composition of the present invention so that a reaction occurs between the metallic material and the water.

### TECHNICAL FIELD

The present invention relates to a hydrogen-generating material composition that reacts with water to generate hydrogen, a formed body thereof, and a method for producing hydrogen using the same.

### BACKGROUND ART

With the recent widespread use of cordless equipment such as a personal computer or portable telephone, secondary batteries used as a power source of the cordless equipment are increasingly required to have a smaller size and higher capacity. At present, a lithium ion secondary battery is being put to practical use as a secondary battery that can achieve a small size, light weight, and high energy density and is growing in demand as a portable power source. However, depending on the type of cordless equipment to be used, the lithium ion secondary battery is not yet reliable enough to ensure a continuous available time.

Under these circumstances, examples of the battery that may meet the above requirements include a polymer electrolyte fuel cell. The polymer electrolyte fuel cell uses a solid polymer electrolyte as an electrolyte, oxygen in the air as a positive active material, and a fuel (hydrogen, methanol, etc.) as a negative active material, and has attracted attention because it is a battery that can be expected to have a higher energy density than the lithium ion battery.

Fuel cells can be used continuously as long as a fuel and oxygen are supplied. Although there are several candidates for fuels used for the fuel cells, the individual fuels have various problems, and a final decision has not been made yet.

For a fuel cell using hydrogen as a fuel, for example, a method for supplying hydrogen as a fuel stored in a high-pressure tank or hydrogen-absorbing alloy tank is employed to some extent. However, a fuel cell using such a tank has a disadvantage that, since both the volume and the mass of the fuel cell as a whole are increased and the energy density is reduced, it is not suitable for a portable power source.

When a fuel cell uses a hydrocarbon fuel, another method for extracting hydrogen by reforming the hydrocarbon fuel may be employed. However, this type of fuel cell requires a reformer and thus poses problems such as supply of heat to the reformer and thermal insulation. Therefore, this fuel cell is not suitable for a portable power source. Moreover, a direct methanol fuel cell, in which methanol is used as a fuel and reacts directly at the electrode, is available. This is miniaturized easily and expected to be a future portable power source. However, a direct methanol fuel cell causes a reduction in both voltage and energy density owing to a crossover in which methanol at the negative electrode passes through the electrolyte and reaches the positive electrode.

Under these circumstances, in order to produce hydrogen as a fuel source for the fuel cell, a method has been proposed that generates hydrogen by causing a chemical reaction between water and a metallic material, such as aluminum, magnesium, silicon, or zinc, at a low temperature of 100° C. or less (see, for example, Patent Documents 1-3).

Among these documents, Patent Document 3 discloses that the reaction efficiency can be improved by adjusting a particle size of a hydrogen-generating material, whereby the content ratio of an exothermic agent or the like can be reduced. It also proposes that the hydrogen-generating material is press-formed into pellets or granules so as to have an increased packing density.

On the other hand, Patent Document 4 describes a hydrogen-generating material that includes aluminum, an aluminum compound as a reaction accelerator, and water or alcohol to be mixed at a ratio of 3 mol or more with respect to 1 mol of the aluminum. It also discloses that the hydrogen generation rate can be controlled if sodium phosphate, sodium citrate, sodium oxalate or the like is added. Further, in Patent Document 5, similarly to the composition disclosed in Patent Document 4, an oxygen absorbent composition that includes aluminum, an aluminum compound, and at least one additive selected from the group consisting of phosphoric acid, citric acid, tartaric acid, and these salts is disclosed, although the application of the composition is different, and it is clearly indicated that the above-described additives function as a suitable inhibitor for the hydrogen generation.

Patent Document 1: JP 2004-231466 A

Patent Document 2: JP 2004-505879 A

Patent Document 3: JP 2006-306700 A

Patent Document 4: JP 2007-131481 A

Patent Document 5: JP 2007-117786 A

However, according to the methods of Patent Documents 1 and 2, in order to develop the hydrogen-generating reaction efficiently, it is necessary to add a large amount of the exothermic agent or catalysts. Accordingly, the ratio of the metallic material decreases, and this causes a problem that the amount of hydrogen to be produced substantially is decreased.

Further, according to the method of Patent Document 3, it is possible to increase the ratio of the metallic material in the hydrogen-generating material, so as to increase the amount of hydrogen that can be extracted. However, when the hydrogen-generating material is formed into a formed body, this prevents water from easily penetrating into the inside of the formed body, and the reaction between the metallic material and water is inhibited. In view of this, more consideration is required to improve the reaction efficiency.

Further, in the method of Patent Document 4 in which an additive is added to the hydrogen-generating material, the additive suppresses the generation of hydrogen. Therefore, this method does not allow hydrogen to be generated efficiently.

### DISCLOSURE OF INVENTION

The present invention has been achieved to solve the above-described problems, and the object is to provide a hydrogen-generating material composition capable of generating hydrogen easily and efficiently, a formed body thereof, and a method for producing hydrogen that generates hydrogen by using them. More specifically, the object of the present invention is to provide a method for producing hydrogen and a hydrogen-generating material composition suitable for providing portability and capable of improving the reaction efficiency of the formed hydrogen-generating material composition.

The inventors of the present invention have found that when a certain amount or more of a water-soluble salt of a hydroxy acid, such as a citric acid and a tartaric acid, is added to a metallic material such as aluminum, the reaction between the metallic material and water is accelerated and thus the hydrogen generation efficiency is improved contrary to the aforementioned disclosures of Patent Documents 4 and 5; more specifically, when the packing density of the hydrogen-generating material composition containing the metallic material and the water-soluble salt of a hydroxy acid is increased, an effect obtained by adding the water-soluble salt of a hydroxy acid can be exhibited fully. The present invention has been achieved on the basis of these findings.

A hydrogen-generating material composition of the present invention contains at least one metallic material selected from the group consisting of aluminum, silicon, zinc, magnesium, and alloys mainly composed of at least one of those metallic elements; and a water-soluble salt of hydroxy acid, wherein a ratio of the water-soluble salt of hydroxy acid to a total amount of the metallic material and the water-soluble salt of hydroxy acid is 1% by mass (mass %) or more.

Further, a first formed body of a hydrogen-generating material of the present invention is produced by forming the hydrogen-generating material composition of the present invention.

Further, a second formed body of a hydrogen-generating material of the present invention is a hydrogen-generating material formed body produced by forming a hydrogen-generating material composition containing at least one metallic material selected from the group consisting of aluminum, silicon, zinc, magnesium, and alloys mainly composed of at least one of those metallic elements, wherein when brought into contact with water, the hydrogen-generating material formed body loses shape, whereby water penetrates into the inside of the formed body.

Further, in the method for producing hydrogen of the present invention, water is supplied to the hydrogen-generating material composition or the hydrogen-generating material formed body of the present invention so that a reaction occurs between the metallic material and the water to generate hydrogen.

By use of the hydrogen-generating material composition of the present invention, hydrogen can be generated easily and efficiently. Further, even when the hydrogen-generating material composition of the present invention is formed into a formed body and a packing density thereof is increased, a decline in reaction efficiency can be prevented, whereby a hydrogen-generating material suitable for providing portability is provided.

### BRIEF DESCRIPTION OF DRAWINGS

FIG. 1 is a schematic cross-sectional view showing an exemplary hydrogen generator used for performing a hydrogen production method of the present invention.

FIG. 2 is a schematic cross-sectional view showing an exemplary fuel cartridge filled with a hydrogen-generating material composition of the present invention.

### DESCRIPTION OF PREFERRED EMBODIMENTS

Hereinafter, Embodiments of the present invention will be described.

### Embodiment 1

First, a hydrogen-generating material composition and a hydrogen-generating material formed body of the present invention will be described. The hydrogen-generating material composition of the present invention contains at least one metallic material selected from the group consisting of aluminum, silicon, zinc, magnesium and alloys mainly composed of at least one of those metallic elements, and a water-soluble salt of hydroxy acid. In the hydrogen-generating material composition described above, a mixing ratio is adjusted so that a ratio of the water-soluble salt of hydroxy acid to a total amount of the metallic material and the water-soluble salt of hydroxy acid becomes 1 mass % or more. When coming into contact with water, the composition serves as a hydrogen source that generates hydrogen by the reaction of the metallic material and water.

The metallic material to be used is at least one metal selected from the group consisting of aluminum, silicon, zinc, and magnesium, or may be an alloy mainly composed of at least one of those metallic elements. In order to increase the amount of hydrogen generated, the content of the metallic element in the alloy (when two or more metallic elements are contained in the alloy, the total content of the elements) preferably is 60 mass % or more, and more preferably is 85 mass % or more. Here, an alloy mainly composed of a metallic element refers to an alloy containing 50 mass % or more of the metallic element. Further, examples of the element that forms an alloy together with the foregoing metallic element include Si, Fe, Cu, Mn, Ni, Ti, Sn and Cr, but it is not particularly limited to these elements. The metallic material is a material as follows: since a relatively stable oxide film is formed on its surface, little progress occurs in the reaction with water when it is in a bulk form such as a plate or block form; but when it is in a powder form, an exothermic reaction with water proceeds smoothly at room temperature or in a heated condition, whereby hydrogen can be produced. Here, in the present specification, the room temperature refers to the temperature ranging from 20° C. to 30° C.

It is considered that the reaction between aluminum, which is one of the metallic materials described above, and water proceeds in accordance with any one of the following formulas (1) to (3). The amount of heat generated in accordance with formula (1) is 419 kJ/mol.

2Al+6H₂O→Al₂O₃.3H₂O+3H₂ (1)

2Al+4H₂O→Al₂O₃.H₂O+3H₂ (2)

2Al+3H₂O→Al₂O₃+3H₂ (3)

The metallic material used for the hydrogen-generating material composition of the present invention generally is composed of particle cores containing the above-described metallic element or alloy in a metallic state, and a surface film (oxide film) covering at least a part of each particle core. In such a reaction between the metallic material and water, when water penetrates into the surface films and arrives at the metal or alloy in the particle cores, the reaction as expressed by the formulas (1) to (3) occurs to generate hydrogen. Among them, as to the reactions expressed by the formulas (1) and (2) that are assumed to be more likely to occur at low temperature of 100° C. or less, hydrates are produced as a reaction product. Since the hydrate has a low degree of solubility in water, it directly precipitates on the particle surface of the metallic material, thereby causing the surface film to become thicker. Then, a phenomenon in which the hydrate having precipitated on the particle surface coagulates with an unreacted portion of the metallic material occurs. This phenomenon prevents water from easily penetrating into the particle cores of the unreacted portion of the metallic material. Particularly in the hydrogen-generating material that is formed into pellets, granules or the like and has a high packing density, the above-described phenomenon is likely to occur on an outer surface of the formed body. This prevents water from easily penetrating into the metallic material inside the formed body, and problems such as a substantial decrease in the hydrogen generation efficiency tend to occur.

However, in the present invention, since the hydrogen-generating material composition contains 1 mass % or more of a water-soluble salt of hydroxy acid with respect to the total amount of the metallic material and the water-soluble salt of hydroxy acid, the reaction between the metallic material and water proceeds efficiently Details are unclear about functions of this water-soluble salt of hydroxy acid as an additive, but it seems that the salt has functions of, for example, enhancing the contact between the metallic material and water, and preventing a reaction product from coagulating with an unreacted portion of the metallic material.

Further, even when the hydrogen-generating material composition is formed into a formed body and the packing density thereof becomes higher, the water-soluble salt contained in the formed body can be hydrated easily when coming into contact with water, whereby the formed body loses shape and water is allowed to penetrate into the inside of the formed body promptly. The above-described function in the formed body is not necessarily exhibited exclusively by the formed body containing the water-soluble salt of hydroxy acid, but it is preferable that the formed body of the hydrogen-generating material composition also contains the water-soluble salt of hydroxy acid, because this possibly is accompanied by the aforementioned effect of accelerating the reaction between the metallic material and water.

Examples of the water-soluble salt of hydroxy acid (oxyacid) used as an additive include metallic salts such as alkali metal salts (lithium salts, sodium salts, potassium salts, etc.), alkaline-earth metal salts (magnesium salts, calcium salts, etc.), aluminum salts, iron salts, copper salts and zinc salts as well as ammonium salts of hydroxy acids such as citric acid, tartaric acid, glycolic acid, mane acid, lactic acid, and tartronic acid. Among them, specifically, the water-soluble salt of hydroxy acid preferably is at least one selected from the group consisting of citrates, tartrates, malates and glycolates. Although details are not clear, the reaction between the metallic material and water can be accelerated further and the hydrogen generation efficiency can be improved further by the addition of at least one selected from the group consisting of citrates, tartrates, malates and glycolates.

The hydroxy acid described above is a generic term used to describe an acid having both a carboxyl group and a hydroxy group in a molecule, and it may have a plurality of carboxyl groups and/or hydroxy groups. When the water-soluble salt of a hydroxy acid having a plurality of carboxyl groups like citric acid is used, an acid salt in which a part of hydrogen atoms of the carboxyl groups still remains may be used, in addition to a normal salt in which all the carboxyl groups have reacted. Further, cations constituting the water-soluble salt are not limited to one kind, and plural kinds of cations may exist in the water-soluble salt. Furthermore, as to compounds that have asymmetric carbons and hence are optical isomers, any of them can be used. As to tartaric acid, for example, any one of the D, L, DL and meso forms of the same may be used.

As the water-soluble salt of hydroxy acid described above, an alkali metal salt or an alkaline-earth metal salt is used preferably, because many of these compounds have high solubility in water. More specifically, trisodium citrate, tripotassium citrate, magnesium hydrogen citrate, disodium tartrate, sodium glycolate, or the like can be used preferably. Among them, in particular, an alkali metal salt of citric acid or glycolic acid, which is highly effective in accelerating the reaction between the metallic material and water, is used preferably.

Further, in the present invention, a water-soluble salt of aliphatic oxyacid is used preferably from the viewpoint of the degree of solubility in water. However, the water-soluble salt is not limited to this, and may be a water-soluble salt of an aromatic oxyacid such as a water-soluble salt of salicylic acid.

In the hydrogen-generating material composition of the present invention, the content ratio of the metallic material and the water-soluble salt of hydroxy acid may be adjusted so that the mass of the water-soluble salt becomes 1% or more when the total mass of these is assumed to be 100. As the ratio of the water-soluble salt is increased, the effect increases and the reaction efficiency improves. Therefore, the ratio of the water-soluble salt to the total amount of the metallic material and the water-soluble salt preferably is 3 mass % or more; more preferably, 5 mass % or more; and most preferably, 10 mass % or more. On the other hand, for increasing the total amount of hydrogen obtained by a reaction by increasing the ratio of the metallic material, the ratio of the water-soluble salt preferably is 40 mass % or less; more preferably, 30 mass % or less; and most preferably, 20 mass % or less. When plural kinds of the above-described water-soluble salts are used, the total amount thereof may be adjusted in the range described above.

Although the shape and particle size of the metallic material in the present invention is not particularly limited, a material satisfying any one of the following requirements (1) to (3) is used preferably. This is because such a metallic material has a superior handling property and a high reaction efficiency. A material satisfying two or more of the following requirements (1) to (3) is used more preferably.
(1) The metallic material includes 80 vol % or more of particles having a particle size of 0.1 μm to 60 μm;
(2) the particles have an average size of 0.1 μm to 30 μm; and
(3) the particles have a shape of flake and a thickness of 0.1 μm to 5 μm.

It is desirable that the metallic material has a shape of flake because the shape allows smoother reaction with water to proceed to the particle core, but the metallic material may have another shape such as a substantially spherical shape, a Rugby ball shape, a liquid-drop shape, or the like.

The “particle size” and “average particle size” in (1) and (2) described above are the values measured by a laser diffraction scattering method. That is, these values can be derived from a particle size distribution that utilizes a scattering intensity distribution detected by projecting laser light to an object to be measured dispersed in a gas phase or a liquid phase such as water, and be based on an accumulated volume percentage. In the present invention, “average particle size” means a value of the diameter with an accumulated volume percentage of 50%, i.e., d₅₀. As a device for measuring the particle size distribution by the laser diffraction scattering method, “MICROTRAC HRA” manufactured by NIKKISO CO., LTD., for example, can be used.

Further, the thickness of the flake-shaped metallic material described in (3) can be obtained by the observation using a scanning electron microscope (SEM).

In the metallic material of the present invention, the content of carbon on the particle surface measured by a combustion-infrared absorption method preferably is 0.5 mass % or less, and more preferably is 0.2 mass % or less. This is because a decrease in the content of carbon on the particle surface causes the compatibility with respect to water to increase, thereby allowing the hydrogen generating reaction to proceed smoothly. However, it practically is difficult to make the content of carbon 0 mass %, and in fact a lower limit of the content of carbon will be about 0.01 mass %.

The hydrogen-generating material composition of the present invention is a composition that reacts with water to generate hydrogen in a reaction container. That is, it is a composition substantially in a dry state before addition of water thereto. However, in some cases, it absorbs a certain amount of moisture from air or the like owing to the water-soluble salt of hydroxy acid or additives such as heat generating materials that will be described later. When a too large amount of the moisture is absorbed in the composition, the reaction may start. Therefore, when the amount of moisture contained in the composition is large, it is desirable to perform treatments such as drying the composition as required.

In the case of adding water to the hydrogen-generating material composition of the present invention, the reaction between the metallic material and water is more likely to proceed at higher temperatures. Therefore, it is desirable to heat the hydrogen-generating material composition or water at the time of the reaction. Exemplary methods of heating the hydrogen-generating material composition or water are as follows: a method of externally heating the reaction container; a method of adding pre-heated water; and a method of making the hydrogen-generating material composition contain a heat generating material that reacts with water to generate heat, and utilizing the reaction heat. In the case where the heat generating material is contained in the hydrogen-generating material composition, the water supplied to the hydrogen-generating material composition to generate hydrogen also reacts with the heat generating material to generate heat, whereby the metallic material and water in the hydrogen-generating material composition are heated, and the reaction is accelerated.

Examples of a material usable as such a heat generating material include a material that reacts with water to generate heat and produces a hydroxide or a hydrate, and a material that reacts with water to generate heat and produce hydrogen.

Examples of the material that reacts with water to generate heat and produces a hydroxide or a hydrate include: oxides or hydroxides of alkali metals (lithium oxide, sodium oxide, sodium hydroxide, etc.); oxides or hydroxides of alkaline-earth metals (calcium oxide, magnesium oxide, calcium hydroxide, etc.); chlorides of alkaline-earth metals (calcium chloride, magnesium chloride, etc.); and sulfated compounds of alkaline-earth metals (calcium sulfate, etc).

Examples of the material that reacts with water to generate heat and produces hydrogen include alkali metals (lithium, sodium, etc.) and alkali metal hydrides (sodium borohydride, potassium borohydride, lithium hydride, etc.). These materials can be used alone or in combination of two or more. Further, it is preferable that the heat generating material is a basic material because it can be dissolved in water used for the hydrogen generating reaction to form a highly-concentrated alkaline solution, and the solution thus obtained dissolves the oxide film formed on the surface of the metallic material, whereby the reactivity with water can be improved. The reaction of dissolving the oxide film sometimes becomes a starting point of the reaction between the metallic material and water. Specifically, it is more preferable that the heat generating material is an alkaline-earth metal oxide because it is a basic material and can be handled easily.

In order to increase the amount of heat obtained by the reaction, the content ratio of the heat generating material in the hydrogen-generating material composition to the total amount of the metallic material and the heat generating material preferably is 0.5 mass % or more, and more preferably is 3.0 mass % or more. On the other hand, for increasing the total amount of hydrogen obtained by the reaction with the increased ratio of the metallic material, the content ratio of the heat generating material preferably is 15 mass % or less, and more preferably is 10 mass % or less. The temperature and hydrogen generation rate at the time of the reaction can be controlled to some extent by adjusting the content of the heat generating material. Here, when the temperature during the reaction becomes too high, the hydrogen generating reaction proceeds too rapidly to be controlled. Therefore, it is preferable to adjust the amount of the heat generating material to be added so that the reaction temperature is kept at 120° C. or below. Further, in order to prevent water used in the reaction from evaporating to be lost, it is more preferable to adjust the amount of the heat generating material to be added so that the reaction temperature is kept at 100° C. or below. On the other hand, from the viewpoint of the efficiency of the hydrogen generating reaction, it is preferable to keep the reaction temperature at 40° C. or above.

The hydrogen-generating material composition of the present invention can be obtained by mixing the above-described metallic material, the water-soluble salt of hydroxy acid, the heat generating material to be added as needed, and the like. Alternatively, a complexed hydrogen-generating material composition obtained by coating the surface of the metallic material with an additive such as the water-soluble salt of hydroxy acid may be used as a hydrogen-generating material composition. Desirably, these materials are mixed as uniformly as possible, but the composition may be configured so that one or more kinds of constituent materials are located disproportionately in one region of the composition. For example, when the heat generating material concentratedly exists in one portion of the composition, the heat generation in that portion by the reaction of the heat generating material and water increases, and the hydrogen generating reaction is more likely to occur from the portion. Accordingly, the time from the start of water supply until the start of the reaction can be reduced. A similar effect can be expected when the water-soluble salt of the hydroxy acid is located disproportionately.

The hydrogen-generating material composition of the present invention can be used as it is, but also can be formed into pellets or granules so as to obtain a shape suitable for providing portability or to increase the amount of hydrogen generated per volume with the increased packing density. An apparent density of the hydrogen-generating material composition of the present invention is approximately 0.7 g/cm³, although it varies depending on the type of the composition. On the other hand, in the case of a formed body of the composition, the apparent density can be increased to approximately 1.0 g/cm³ to 2.5 g/cm³, and the amount of the composition per unit volume can be increased. A binder such as carboxymethylcellulose may be added to the composition for improving formability.

### Embodiment 2

Next, a method for producing hydrogen of the present invention will be described. The method for producing hydrogen of the present invention is a method in which water is supplied to the hydrogen-generating material composition or the hydrogen-generating material formed body of the present invention described in Embodiment 1 so that a reaction occurs between the aforementioned metallic material and water to generate hydrogen. As described in Embodiment 1, the method for producing hydrogen of the present invention preferably includes the step of heating the hydrogen-generating material composition, the hydrogen-generating material formed body or the water.

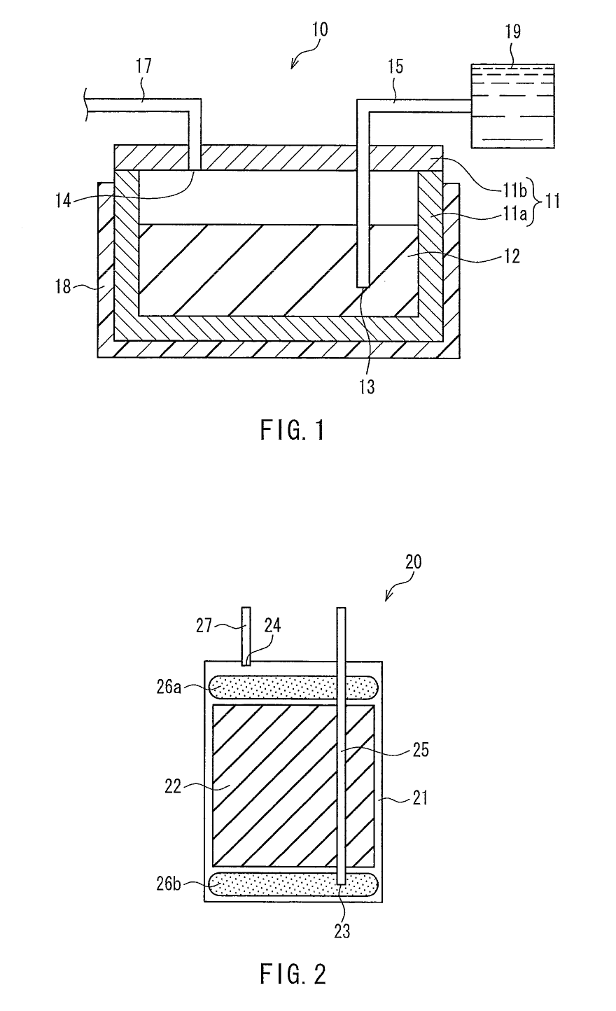

Hereinafter, the method for producing hydrogen of the present invention will be described based on the drawings. FIG. 1 is a schematic cross-sectional view showing an exemplary hydrogen generator used for performing the hydrogen production method of the present invention. In FIG. 1, a hydrogen generator 10 includes a water inlet 13, a hydrogen outlet 14, and a reaction container 11 that is hermetically sealed to allow the reaction of a hydrogen-generating material composition 12 and water to take place. A micropump 19 can supply water continuously to the hydrogen-generating material composition 12 through a water supply pipe 15 and the water inlet 13. Further, the reaction container 11 is composed of a body 11a and a cover 11b. The supplied water reacts with the hydrogen-generating material composition 12 to generate hydrogen in the reaction container 11. The generated hydrogen passes through the hydrogen outlet 14 and is drawn from a hydrogen discharge pipe 17 to the outside. In the Embodiment of FIG. 1, a heat insulator 18 covers the reaction container 11 so that the hydrogen generating reaction is sustained while preventing a decrease in temperature in the reaction container 11 during the reaction.

The suitable material for the reaction container 11 is not limited particularly, and may be any material as far as it is substantially impermeable to water and hydrogen and does not cause the container to be damaged when it is heated at about 100° C. For example, metals such as aluminum, titanium and nickel, resins such as polyethylene, polypropylene and polycarbonate, ceramics such as alumina, silica and titania, and glass (particularly heat-resistance glass) can be used. The water supply pipe 15 and the hydrogen discharge pipe 17 can be made of the same materials as the reaction container 11. A material with high thermal insulating properties such as styrofoam may be used for the heat insulator 18. If necessary, a filter such as a gas-liquid separation film may be attached to the hydrogen outlet 14 to prevent the contents in the container, except for hydrogen, from leaking out.

In view of portability, the hydrogen generator may be in the form of, for example, a portable fuel cartridge as shown in FIG. 2, when it is incorporated into a small fuel cell or portable electronic equipment. In FIG. 2, a fuel cartridge 20 has a configuration as follows: a hydrogen-generating material composition 22 is sealed inside a reaction container 21; and, like the aforementioned hydrogen generator of FIG. 1, the cartridge includes a water inlet 23 through which water is supplied to the hydrogen-generating material composition 22 and a hydrogen outlet 24 through which hydrogen generated in the reaction container 21 is discharged to the outside. The fuel cartridge 20 is inserted into a fuel cell or portable electronic equipment, and water is supplied to the inside of the cartridge through a water supply pipe 25 by using a micropump or the like. Alternatively, another container filled with water may be provided in a part of the fuel cartridge 20 beforehand so that the water is supplied in the reaction container 21 after the fuel cartridge 20 is inserted into a fuel cell or portable electronic equipment.

While part of the supplied water is retained by water absorbing materials 26a and 26b, the remainder wets the hydrogen-generating material composition 22, and then the hydrogen generating reaction starts. The generated hydrogen is supplied to a negative electrode of the fuel cell through a hydrogen discharge pipe 27. The water absorbing materials 26a and 26b are not necessarily required, but they allow a variation in the hydrogen generation rate with time to be suppressed to some extent since the water retained by them also is supplied to the hydrogen-generating material composition 22 in accordance with the water consumption resulting from the hydrogen generating reaction. The water absorbing materials 26a and 26b are not particularly limited as long as it can absorb and retain water. In general, absorbent cotton, a nonwoven fabric, or the like can be used.

When the aforementioned water-soluble salt of hydroxy acid is added to the hydrogen-generating material composition, the volume of the product generated by the reaction between the composition and water becomes larger as compared with the product generated by the reaction between water and a hydrogen-generating material composition not containing any water-soluble salt. Because of this, in the stage where the reaction proceeds and a large amount of a reaction product precipitates, it suppresses the penetration of water into the inside of the hydrogen-generating material composition, whereby the reaction rate may decrease. For preventing this situation, the reaction containers 11 and 21 may be formed of, for example, a laminate film of a resin and a metal such as aluminum so that the containers can change their shapes in accordance with the volume change of the composition by the reaction. Further, when a formed hydrogen-generating material composition is used, spaces may be provided between the formed body and the reaction containers 11 and 21 for corresponding to the volume expansion of the composition.

With the use of the above-described deformable reaction containers or the setting of spaces in the reaction containers for corresponding to the volume change of the hydrogen-generating material composition, water easily can penetrate into the inside of the hydrogen-generating material composition even when the reaction proceeds, whereby the effect of the present invention can be improved further.

Furthermore, it is preferable that the hydrogen generator is provided with a pressure relief valve. For example, even when an increase in the hydrogen generating rate raises the internal pressure of the generator, hydrogen is discharged through the pressure relief valve to the outside of the generator, thereby making it possible to prevent the generator from breaking due to bursting or the like. The pressure relief valve may be disposed anywhere as long as the hydrogen generated in the container containing the hydrogen-generating material composition can be discharged. For example, as to the generator shown in FIG. 2, the pressure relief valve may be provided at any locations between the hydrogen discharge pipe 27 and a fuel cell or portable electronic equipment.

Hydrogen produced by reforming a hydrocarbon fuel includes CO and CO₂ and thus causes a problem of poisoning due to these gases in a polymer electrolyte fuel cell that operates at 100° C. or less. In contrast, hydrogen produced by using the hydrogen-generating material composition of the present invention includes neither of these gases and does not cause such a problem. Moreover, since the hydrogen generating reaction involves water, the hydrogen gas generated includes a moderate amount of moisture and can be used suitably for the fuel cell that uses hydrogen as a fuel.

In the case of externally heating the hydrogen-generating material composition, a method can be adopted in which the reaction container that contains the hydrogen-generating material composition and water are heated externally by, for example, electrical heating by passing electricity through a resister, or chemical heating by an exothermic reaction, as a heat source. The type of the resistor is not particularly limited, and for example, silicon carbide, a PTC thermistor, and metallic heating elements such as a nichrome wire and a platinum wire can be used. Further, the aforementioned exothermal reaction is not particularly limited, and for example, the heat generated by the aforementioned reaction between the heat generating material and water, or the heat generated by the reaction between iron and oxygen can be used.

Further, since the reaction between the metallic material and water also is an exothermic reaction, hydrogen can be generated continuously without the heat source if the reaction heat is prevented from being released by the heat insulator 18 of FIG. 1 and is used to increase the temperature of the hydrogen-generating material composition and water. In other words, even if heating is performed only at the beginning of the reaction and is stopped after the start of the generation of hydrogen, the heated state can be maintained by the heat generated by the hydrogen generating reaction.

Moreover, the amount of hydrogen generated can be controlled by controlling the amount of supplied water that is caused to react with the hydrogen-generating material composition.

Hereinafter, the present invention will be described more specifically with reference to Examples.

### Example 1

Aluminum powder having an average particle size of 6 μm (the ratio of particles with a particle size of 60 μm or less: 100 mass %) produced by a gas atomizing method was used as a metallic material. Trisodium citrate powder was used as an additive. The aluminum powder and the trisodium citrate powder were mixed in a mortar at ratios as shown in Table 1, whereby hydrogen-generating material compositions were obtained. Next, each of the hydrogen-generating material compositions was press-formed so as to produce a 0.5 g formed body in a pellet form having a diameter of 10 mm, a thickness of about 3.7 mm, and an apparent density of 1.7 g/cm³. Here, the apparent density of the formed body was evaluated by dividing the mass of the formed body by the volume obtained by the thickness and diameter.

Then, the formed body and 10 g of pure water were put in a glass container (capacity: 50 cm³) with a resistor provided outside. The container was heated at 50° C. by allowing electricity to pass through the resistor. By contacting with water, each of the formed bodies of the hydrogen-generating material compositions lost shape, and the water penetrated into the inside of the composition, whereby the metallic material and water smoothly reacted with each other to generate hydrogen. The generated hydrogen was collected by a water displacement method, and the reaction rate of aluminum as well as the total amount of the generated hydrogen in 50 hours from the beginning of the reaction was determined. The reaction rate of aluminum was obtained as a ratio of the actual amount of generated hydrogen with respect to the theoretical amount of generated hydrogen that was calculated from the mass of aluminum contained in the formed body based on the theoretical amount of hydrogen generated per gram of aluminum at 25° C. at 1 atmosphere (1360 ml).

### Example 2

Formed bodies of hydrogen-generating material compositions of Example 2 were produced in the same manner as in Example 1, except that tripotassium citrate powder was mixed at ratios shown in Table 1, in place of the trisodium citrate powder. Then, hydrogen was generated using the obtained formed bodies.

### Example 3

Formed bodies of hydrogen-generating material compositions of Example 3 were produced in the same manner as in Example 1, except that disodium tartrate powder was mixed at ratios shown in Table 1, in place of the trisodium citrate powder. Then, hydrogen was generated using the obtained formed bodies.

### Example 4

Formed bodies of hydrogen-generating material compositions of Example 4 were produced in the same manner as in Example 1, except that sodium glycolate powder was mixed at ratios shown in Table 1, in place of the trisodium citrate powder. Then, hydrogen was generated using the obtained formed bodies.

### Example 5

A 0.5 g formed body of a hydrogen-generating material composition of Example 5 was produced in the same manner as in Example 1, except that one of the hydrogen-generating material compositions used in Example 1 containing the aluminum powder and the trisodium citrate powder at a ratio of 90:10 (mass ratio) was press-formed into a formed body having a diameter of 10 mm, a thickness of about 3.2 mm, and an apparent density of 2.0 g/cm³. Then, hydrogen was generated using the obtained formed body.

### Comparative Example 1

A formed body of a hydrogen-generating material composition of Comparative Example 1 was produced in the same manner as in Example 1, except that 0.5 g of the aluminum powder of Example 1 was used as it is without any additives mixed therein. Then, hydrogen was generated using the obtained formed body.

### Comparative Example 2

A formed body of a hydrogen-generating material composition of Comparative Example 2 was produced in the same manner as in Example 1, except that the ratio between the aluminum powder and the trisodium citrate powder was 99.5:0.5 (mass ratio). Then, hydrogen was generated using the obtained formed body.

### Comparative Example 3

A formed body of a hydrogen-generating material composition of Comparative Example 3 was produced in the same manner as in Example 1, except that calcium oxide powder was mixed at a ratio shown in Table 1, in place of the trisodium citrate powder. Then, hydrogen was generated using the obtained formed body. In other words, in Comparative Example 3, the hydrogen-generating material composition contained a heat generating material, in place of the water-soluble salt of hydroxy acid.

### Comparative Example 4

A formed body of a hydrogen-generating material composition of Comparative Example 4 was produced in the same manner as in Example 1, except that citric acid powder was mixed at a ratio shown in Table 1, in place of the trisodium citrate powder. Then, hydrogen was generated using the obtained formed body. In other words, in Comparative Example 4, the hydrogen-generating material composition contained the hydroxy acid itself, in place of the water-soluble salt of hydroxy acid.

### Comparative Example 5

A formed body of a hydrogen-generating material composition of Comparative Example 5 was produced in the same manner as in Example 1, except that sodium acetate powder was mixed at a ratio shown in Table 1, in place of the trisodium citrate powder. Then, hydrogen was generated using the obtained formed body. In other words, in Comparative Example 5, the hydrogen-generating material composition contained a water-soluble salt of carboxylic acid with carboxyl groups and without hydroxy groups, in place of the water-soluble salt of hydroxy acid.

### Comparative Example 6

A formed body of a hydrogen-generating material composition of Comparative Example 6 was produced in the same manner as in Example 1, except that disodium succinate powder was mixed at a ratio shown in Table 1, in place of the trisodium citrate powder. Then, hydrogen was generated using the obtained formed body. In other words, in Comparative Example 6, the hydrogen-generating material composition contained a water-soluble salt of polycarboxylic acid with carboxyl groups and without hydroxy groups, in place of the water-soluble salt of hydroxy acid.

### Comparative Example 7

A formed body of a hydrogen-generating material composition of Comparative Example 7 was produced in the same manner as in Example 1, except that trimagnesium dicitrate powder was mixed at a ratio shown in Table 1, in place of the trisodium citrate powder. Then, hydrogen was generated using the obtained formed body. In other words, in Comparative Example 7, the hydrogen-generating material composition contained a water-insoluble salt of hydroxy acid, in place of the water-soluble salt of hydroxy acid.

Also in Examples 2 to 5 and Comparative Examples 1 to 7, the total amount of generated hydrogen as well as the reaction rate of aluminum were determined in the same manner as in Example 1. Table 1 shows the type of the additive, the content ratio of the additive, the total amount of generated hydrogen (generated hydrogen amount), and the reaction rate of aluminum (metallic material) of each of the formed bodies of the hydrogen-generating material compositions of Examples 1 to 5 and Comparative Examples 1 to 7.

TABLE 1

| | | | | Generated | Reaction rate of |
|---|---|---|---|---|---|
| | | Content ratio (mass %) | | hydrogen amount | metallic material |
| | Type of additive | Metallic material | Additive | (ml) | (%) |
| Ex. 1 | trisodium citrate | 97 | 3 | 250 | 38 |
| | | 95 | 5 | 340 | 53 |
| | | 90 | 10 | 502 | 82 |
| | | 80 | 20 | 479 | 88 |
| | | 70 | 30 | 438 | 92 |
| | | 50 | 50 | 337 | 99 |
| Ex. 2 | tripotassium citrate | 80 | 20 | 444 | 82 |
| | | 70 | 30 | 464 | 97 |
| Ex. 3 | disodium tartrate | 80 | 20 | 402 | 74 |
| | | 70 | 30 | 419 | 88 |
| Ex. 4 | sodium glycolate | 97 | 3 | 419 | 63 |
| | | 95 | 5 | 471 | 73 |
| | | 90 | 10 | 491 | 80 |
| | | 80 | 20 | 457 | 83 |
| | | 70 | 30 | 382 | 80 |
| Ex. 5 | trisodium citrate | 90 | 10 | 514 | 84 |
| Comp. Ex. 1 | — | 100 | 0 | 114 | 17 |
| Comp. Ex. 2 | trisodium citrate | 99.5 | 0.5 | 121 | 18 |
| Comp. Ex. 3 | calcium oxide | 90 | 10 | 121 | 20 |
| Comp. Ex. 4 | citric acid | 90 | 10 | 56 | 9 |
| Comp. Ex. 5 | sodium acetate | 90 | 10 | 116 | 19 |
| Comp. Ex. 6 | disodium succinate | 90 | 10 | 117 | 19 |
| Comp. Ex. 7 | trimagnesium dicitrate | 90 | 10 | 169 | 28 |

The formed bodies of the hydrogen-generating material compositions of Examples 1 to 5, each of which contained 1 mass % or more of the water-soluble salt of hydroxy acid as an additive, exhibited improved reaction rates of aluminum and increased amounts of generated hydrogen compared with the formed body of Comparative Example 1, to which the water-soluble salt of hydroxy acid was not added. The reaction rate of aluminum improved as the content ratio of the additive increased, which however caused the ratio of aluminum power serving as a hydrogen source to decrease, and the amount of the generated hydrogen began to fall from the maximum value when the ratio of the additive exceeded the preferable range.

Even after water was supplied to the container, the formed body of the hydrogen-generating material composition of Comparative Example 1 maintained its shape. In view of this, it is considered that a required amount of water for causing the hydrogen-generating reaction did not penetrate into the inside of the formed body, and hence the reaction stopped in the vicinity of the outer surface of the formed body, whereby the reaction rate of aluminum decreased and the amount of the generated hydrogen decreased.

The formed body of Comparative Example 2, in which less than 1 mass % of the water-soluble salt of hydroxy acid was contained, also did not fully exhibit the function of the additive and was unable to improve the reaction efficiency.

Further, as to the formed body of Comparative Example 3 in which calcium oxide as a heat generating material (which can be expected to accelerate the reaction) was contained in place of the water-soluble salt of hydroxy acid, the heat generating material existing in the vicinity of the outer surface of the formed body reacted with water to generate heat, thereby allowing the reaction efficiency to slightly improve compared with Comparative Example 1. However, the amount of generated hydrogen was not increased because water did not penetrate into the inside of the formed body.

Further, the formed bodies of Comparative Examples 4 to 7, each of which contained a compound having a configuration similar to that of the water-soluble salt of hydroxy acid in place of the water-soluble salt of hydroxy acid, did not exhibit a greatly improved reaction efficiency, and hence a sufficient amount of hydrogen was not secured. Since the formed bodies of Comparative Examples 4 to 7 maintained their shapes in the reaction container, it is considered that water did not penetrate into the inside of the formed bodies.

The invention may be embodied in other forms without departing from the spirit or essential characteristics thereof. The Embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

As described above, according to the present invention, it is possible to generate hydrogen easily and efficiently at a low temperature of 100° C. or less. Specifically, even when the hydrogen-generating material composition of the present invention is formed into a formed body so that the packing density thereof is increased, a decline in reaction efficiency can be prevented, whereby a hydrogen-generating material composition suitable for providing portability is provided. Therefore, it widely can be used for a hydrogen fuel source of fuel cells, in particular, fuel cells for compact portable devices.

1. A hydrogen-generating material composition comprising:
at least one metallic material selected from the group consisting of aluminum, silicon, zinc, magnesium, and alloys mainly composed of at least one of those metallic elements; and
a water-soluble salt of hydroxy acid,
wherein a ratio of the water-soluble salt of hydroxy acid to a total amount of the metallic material and the water-soluble salt of hydroxy acid is 1 mass % or more.

2. The hydrogen-generating material composition according to claim 1, comprising at least one member selected from the group consisting of citrates, tartrates, malates, and glycolates, as the water-soluble salt of hydroxy acid.

3. The hydrogen-generating material composition according to claim 1, comprising an alkali metal salt or an alkaline-earth metal salt of hydroxy acid, as the water-soluble salt of hydroxy acid.

4. The hydrogen-generating material composition according to claim 1, comprising an alkali metal salt of citric acid or glycolic acid, as the water-soluble salt of hydroxy acid.

5. The hydrogen-generating material composition according to claim 1, wherein the ratio of the water-soluble salt of hydroxy acid to a total amount of the metallic material and the water-soluble salt of hydroxy acid is 20 mass % or less.

6. The hydrogen-generating material composition according to claim 1, wherein the metallic material satisfies any one of the following (1) to (3):
(1) the metallic material includes 80 vol % or more of particles having a particle size of 0.1 μm to 60 μm;
(2) the particles have an average size of 0.1 μm to 30 μm; and
(3) the particles have a shape of flake and a thickness of 0.1 μm to 5 μm.

7. The hydrogen-generating material composition according to claim 1, further comprising a heat generating material that generates heat by reacting with water.

8. A hydrogen-generating material formed body produced by forming a hydrogen-generating material composition,
wherein the hydrogen-generating material composition includes:
at least one metallic material selected from the group consisting of aluminum, silicon, zinc, magnesium, and alloys mainly composed of at least one of those metallic elements; and
a water-soluble salt of hydroxy acid, and
a ratio of the water-soluble salt of hydroxy acid to a total amount of the metallic material and the water-soluble salt of hydroxy acid is 1 mass % or more.

9. The hydrogen-generating material formed body according to claim 8, wherein an apparent density thereof is 1.0 g/cm³ to 2.5 g/cm³.

10. A hydrogen-generating material formed body produced by forming a hydrogen-generating material composition comprising at least one metallic material selected from the group consisting of aluminum, silicon, zinc, magnesium, and alloys mainly composed of at least one of those metallic elements,
wherein when brought into contact with water, the hydrogen-generating material formed body loses shape, whereby water penetrates into the inside of the formed body.

11. The hydrogen-generating material formed body according to claim 10, further comprising a water-soluble salt of hydroxy acid,
wherein a ratio of the water-soluble salt of hydroxy acid to a total amount of the metallic material and the water-soluble salt of hydroxy acid is 1 mass % or more.

12. A method for producing hydrogen, wherein water is supplied to the hydrogen-generating material composition according to claim 1 so that a reaction occurs between the metallic material and the water to generate hydrogen.

13. The method for producing hydrogen according to claim 12, comprising the step of heating the hydrogen-generating material composition or the water.

14. A method for producing hydrogen, wherein water is supplied to the hydrogen-generating material formed body according to claim 8 so that a reaction occurs between the metallic material and the water to generate hydrogen.

15. The method for producing hydrogen according to claim 14, comprising the step of heating the hydrogen-generating material formed body or the water.

16. A method for producing hydrogen, wherein water is supplied to the hydrogen-generating material formed body according to claim 10 so that a reaction occurs between the metallic material and the water to generate hydrogen.

17. The method for producing hydrogen according to claim 16, comprising the step of heating the hydrogen-generating material formed body or the water.
